(19) United States
(12) Patent Application Publication
(10) Pub. No.: US 2023/0182449 A1
(43) Pub. Date: Jun. 15, 2023

(54) POLYMER FILM

(71) Applicant: CHANG CHUN PETROCHEMICAL CO., LTD., Taipei City (TW)

(72) Inventor: Tzu-Jung Huang, Taipei City (TW)

(21) Appl. No.: 17/853,604

(22) Filed: Jun. 29, 2022

(30) Foreign Application Priority Data
Dec. 10, 2021 (CN) 202111505156.1
Dec. 10, 2021 (TW) 110146370

(51) Int. Cl. B32B 17/10; B32B 3/26; B32B 27/08; B32B 27/30; B32B 27/22

(52) U.S. Cl. CPC B32B 17/10761; B32B 17/10036; B32B 17/10605; B32B 3/263; B32B 27/08; B32B 27/306; B32B 27/22; B32B 2307/732; B32B 2307/308; B32B 2457/20

(57) ABSTRACT

The present disclosure relates to a polymer film comprising a polyvinyl acetal resin and a plasticizer, wherein the polymer film is single-layer or multilayer a smallest value of a loss factor of the polymer film occurs at a temperature ranging from 40° C. to 60° C. The polymer film provided herein exhibits improved fluidity and processability.

### BACKGROUND OF THE INVENTION

### 1. Technical Field

The present invention relates mainly to a polymer film and more particularly to a polymer film suitable for use as an intermediate film in laminated glass.

### 2. Description of Related Art

Polymer films nowadays have extensive application and can be used to make a diversity of materials. Polymer films have desirable film-forming properties and, by adjusting their raw materials or manufacturing processes, can be provided with such outstanding features as high transparency, elasticity, toughness, resistance to strong bases, resistance to oil, flexibility, weather resistance, and impact resistance at low temperatures. One common ingredient of polymer films is polyvinyl acetal resins, whose special chemical structures provide satisfactory adherence to glass, metal, ceramic powder, plastic, leather, and wood. Besides, polyvinyl acetal resins allow pigments and dyes to be well dispersed therein and are highly compatible with various other resins.

In terms of application, polymer films made from polyvinyl acetal resins may exist in many forms, including single-layer films, multilayer films, and intermediate films sandwiched between glass layers. Before being made into the end product, however, a polyvinyl acetal resin film requires not a few processing steps such as film extending, cutting, and other steps that involve film deformation. Processability, therefore, has become a major indicator of polyvinyl acetal resin films.

More specifically, the processability of a polymer is highly correlated to the viscoelasticity of the polymer, wherein viscoelasticity is a deformation modulus that determines whether a deformation of a material is reversible. Parameters associated with viscoelasticity include the loss factor (tan δ) and the corresponding glass transition temperature (Tg). Tan δ, which is also referred to as the loss factor, the damping factor, or the loss tangent, indicates one of the viscoelasticity properties, or more specifically the damping characteristic, of a material and is equivalent to the ratio of the loss modulus (G″) to the storage modulus (G′) of the material. The temperature corresponding to a peak value of the loss factor is known as a glass transition temperature, which can be viewed as a temperature at which a substance is convertible between a glass state, in which the substance has low fluidity, and a highly elastic state, in which the substance has high fluidity and is soft.

### BRIEF SUMMARY OF THE INVENTION

This part of the specification aims to provide a brief summary of the invention so as to enable a basic understanding of the invention. The brief summary of the invention is neither a complete description of the invention nor intended to point out the important or key elements of certain embodiments of the invention or define the scope of the invention.

The inventor of the present invention has found that the processability of a polymer film is further correlated to the viscoelasticity of the film under the temperature condition of the intended processing process, and that it should be feasible to improve the processability of the polymer film by modulating its viscoelasticity under that temperature condition. A polyvinyl acetal resin film for use as an intermediate film in laminated glass is generally required to go through a film extending process, in which the film is stretched to the desired shape. Therefore, if the film is too hard, it will be difficult to stretch the film, in particular at the rear end; if the film is too soft, pattern collapse will take place while the film is being extended. It has been found that the viscoelasticity of a polymer film at a temperature ranging from 40° C. to 60° C. is critical to whether the film can be processed with ease, so by defining the temperature range in which the smallest value of the loss factor (tan δ) of a polymer film is desired to occur, the invention helps improve the fluidity and processability of such films.

More specifically, one aspect of the present invention provides a polymer film, comprising a polyvinyl acetal resin and a plasticizer, wherein the polymer film is single-layer or multilayer, and a smallest value of a loss factor of the polymer film occurs at a temperature ranging from 40° C. to 60° C.

According to an embodiment of the present invention, the smallest value of the loss factor ranges from 0.13 to 0.19.

According to an embodiment of the present invention, when the polymer film is single-layer, the temperature at which the smallest value of the loss factor occurs is higher than a glass transition temperature of the polymer film; or when the polymer film is multilayer, the temperature at which the smallest value of the loss factor occurs is higher than a highest glass transition temperature of the polymer film.

According to an embodiment of the present invention, the polyvinyl acetal resin is polyvinyl butyral (PVB).

According to an embodiment of the present invention, the polymer film has a thickness ranging from 0.2 mm to 2 mm.

According to an embodiment of the present invention, after receiving a heat treatment at 50° C. for 1 hour, the thermal shrinkage (%) ((length before heating−length after heating)/length before heating×100) of the polymer film is 2% to 5%.

According to one embodiment of the present invention, when measured according to ASTM D412, the polymer film has an elongation percentage ranging from 220% to 300%.

According to an embodiment of the present invention, when the polymer film is single-layer, the polyvinyl acetal resin in the polymer film has a hydroxyl group content ranging from 27 mol % to 31 mol % and/or a degree of acetalization ranging from 68 mol % to 72 mol %.

According to an embodiment of the present invention, when the polymer film is single-layer, the plasticizer in the polymer film is in an amount of 30 to 60 parts by weight while the polyvinyl acetal resin in the polymer film is in an amount of 100 parts by weight.

According to an embodiment of the present invention, when the polymer film is single-layer, the polymer film is a film for use in a head-up display (HUD).

According to an embodiment of the present invention, the polymer film has a thick end and a thin end, and the thin end has a smaller thickness than the thick end.

According to an embodiment of the present invention, when the polymer film is multilayer, the polymer film is a three-layer structure consisting of an upper protective layer, a lower protective layer, and an interlayer sandwiched between the upper protective layer and the lower protective layer.

According to an embodiment of the present invention, the polyvinyl acetal resin in each said protective layer has a hydroxyl group content ranging from 27 mol % to 31 mol % and/or a degree of acetalization ranging from 68 mol % to 72 mol %.

According to an embodiment of the present invention, the plasticizer in each said protective layer is in an amount of 30 to 60 parts by weight while the polyvinyl acetal resin in each said protective layer is in an amount of 100 parts by weight.

According to an embodiment of the present invention, the polyvinyl acetal resin in the interlayer has an hydroxyl group content ranging from 22 mol % to 27 mol % and/or a degree of acetalization ranging from 62 mol % to 68 mol %.

According to an embodiment of the present invention, the plasticizer in the interlayer is in an amount of 60 to 90 parts by weight while the polyvinyl acetal resin in the interlayer is in an amount of 100 parts by weight.

According to an embodiment of the present invention, the polymer film is used as an intermediate film in laminated glass and has a thickness ranging from 0.5 mm to 2 mm.

According to an embodiment of the present invention, the thickness of the polymer film is 0.8 mm, with the upper protective layer having a thickness of 0.335 mm, the interlayer having a thickness of 0.13 mm, and the lower protective layer having a thickness of 0.335 mm.

The present invention is advantageous in that, based on the features defined herein, the polymer film provided by the invention has outstanding processability and fluidity.

BRIEF DESCRIPTION OF THE SEVERAL VIEWS OF THE DRAWINGS

The foregoing and other objectives, features, and advantages of the present invention can be better understood by referring to the following detailed description of some illustrative embodiments in conjunction with the accompanying drawings, in which:

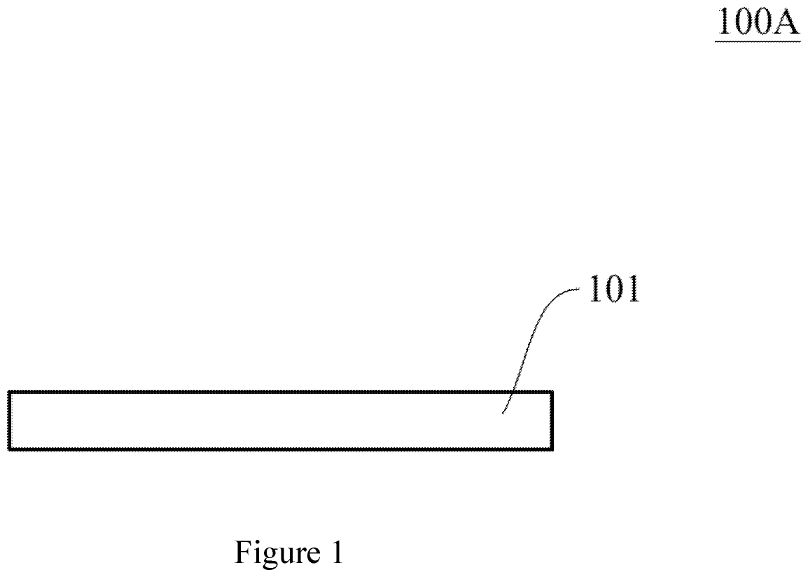

FIG. 1 to FIG. 3 are sectional views of the polymer films in different embodiments of the invention; and

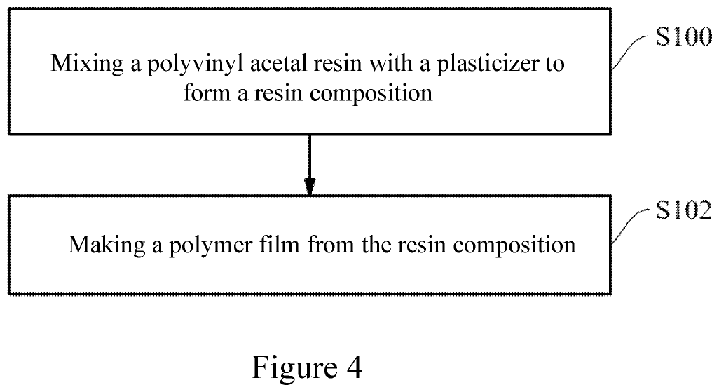

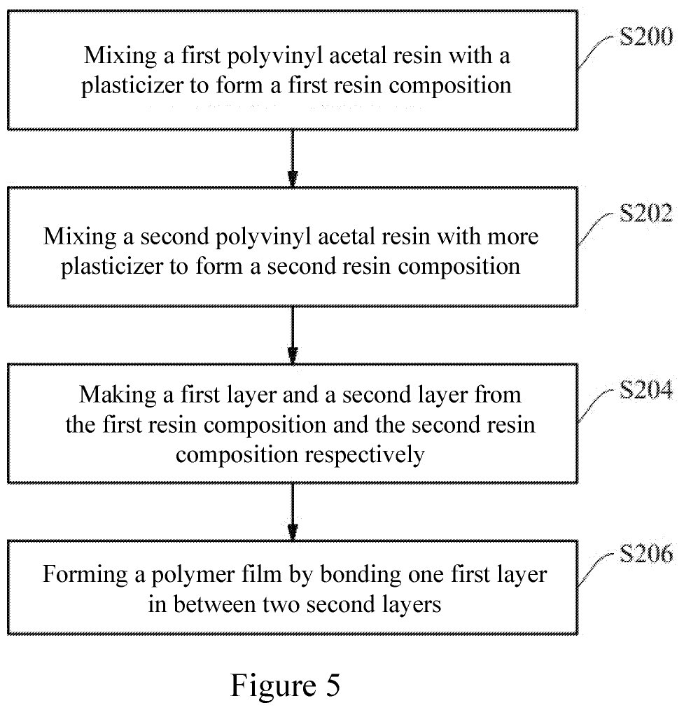

FIG. 4 and FIG. 5 are flowcharts of the polymer film manufacturing processes in different embodiments of the invention.

In accordance with common practice, the various features and elements in the drawings are not drawn to scale, but are drawn in order to best represent specific features and elements relevant to the present invention. Otherwise, the same or similar reference numerals are used to refer to similar elements and parts among the different drawings.

### DETAILED DESCRIPTION OF THE INVENTION

In order to make the description of the present invention more detailed and complete, the following provides an illustrative description for the implementation aspects and specific embodiments of the present invention, but this is not the only way to implement or use the specific embodiments of the present invention. form. In this specification and the scope of the appended claims, “a” and “the” may also be construed as plural unless the context dictates otherwise. In addition, within the scope of this specification and the appended patent applications, unless otherwise stated, “disposed on something” can be regarded as directly or indirectly in contact with the surface of something by attachment or other forms. The definition of the surface judgment should be based on the context/paragraph semantics of the description and common knowledge in the field to which this description pertains.

Notwithstanding that the numerical ranges and parameters used to define the invention are approximate numerical values, the numerical values set forth in the specific examples have been presented as precisely as possible. Any numerical value, however, inherently contains the standard deviation resulting from individual testing methods. As used herein, “about” generally means that the actual value is within plus or minus 10%, 5%, 1%, or 0.5% of a particular value or a range. Alternatively, the word “about” means that the actual value lies within an acceptable standard error of the mean, as determined by one of ordinary skill in the art to which this invention pertains. Therefore, unless otherwise stated to the contrary, the numerical parameters disclosed in this specification and the accompanying claims are approximate numerical values and may be changed as required. At a minimum, these numerical parameters should be construed to mean the number of significant digits indicated and the numerical values obtained by applying ordinary rounding.

The present invention provides a polymer film that includes a polyvinyl acetal resin and a plasticizer. More specifically, the polyvinyl acetal resin referred to herein is a resin composition prepared by condensation of polyvinyl alcohol (PVA) with an aldehyde. The PVA may be obtained through saponification of a polyvinyl ester, with the degree of saponification of the PVA generally ranging from 70 mol % to 99.9 mol %, such as 70 mol %, 75 mol %, 80 mol %, 85 mol %, 90 mol %, 95 mol %, 99 mol % or 99.9 mol %. The aldehyde is generally an aldehyde with a carbon number ranging from 1 to 10, such as methanol (also known as formaldehyde), ethanal (also known as acetaldehyde), propanal (also known as propionaldehyde), butanal (also known as butyraldehyde), isobutyraldehyde, pentanal (also known as valeraldehyde), 2-ethylbutyraldehyde, hexanal (also known as caproaldehyde), octanal, nonanal (also known as pelargonaldehyde), decanal (also known as capraldehyde), or benzaldehyde. Preferably, the aldehyde is propionaldehyde, butyraldehyde, isobutyraldehyde, caproaldehyde, or valeraldehyde. More preferably, the aldehyde is propionaldehyde, butyraldehyde, or isobutyraldehyde. In one embodiment of the invention, the polyvinyl acetal is polyvinyl butyral (PVB).

The plasticizer, which is often used in conjunction with a polyvinyl acetal resin to modulate the viscoelasticity of the resulting material, may be selected from the group consisting of a monobasic ester, a polybasic ester, an organic phosphoric acid, and an organic phosphorous acid, without limitation. More specifically, the plasticizer may be selected from the group consisting of triethylene glycol bis(2-ethylhexanoate) (3GO), tetraethylene glycol bis(2-ethylhexanoate), triethylene glycol bis(2-ethylbutanoate), tetraethylene glycol bis(2-ethylbutanoate), triethylene glycol diheptanoate, tetraethylene glycol diheptanoate, dihexyl adipate, dioctyl adipate, hexyl cyclohexyl adipate, diisononyl adipate, heptyl nonyl adipate, dibutyl sebacate, bis[2-(2-butoxyethoxy)ethyl] adipate, polyadipate, propylene glycol dibenzoate, dipropylene glycol dibenzoate, tripropylene glycol dibenzoate, polypropylene glycol dibenzoate, 2,2,4-trimethyl-1,3-pentanediyl dibenzoate, isodecyl benzoate, 2-ethylhexyl benzoate, di-isononyl phthalate, dibutoxy ethyl terephthalate, castor oil, methyl ricinoleate, soybean oil, and epoxidized soybean oil.

The polymer film provided by the present invention is a single-layer or multilayer structure, and the smallest value of the loss factor of the polymer film occurs at a temperature ranging from 40° C. to 60° C., such as but not limited to 42.28° C., 48.29° C., 49.77° C., 51.43° C., 52.23° C., 54.21° C., 56.18° C., 58.27° C. or 59.14° C.

The term “loss factor” refers to tan δ (also known as the damping factor or the loss tangent), which indicates one of the viscoelasticity properties, or more specifically the damping characteristic, of a material and is equivalent to the ratio of the loss modulus (G″, also known as the viscosity modulus) to the storage modulus (G′, also known as the elasticity modulus) of the material. Without being limited by specific theories, the loss factor has a smallest value, which indicates that the associated energy is mainly stored, and once the temperature goes beyond that corresponding to the smallest value, the energy is gradually expended such that viscosity begins to increase. Therefore, processing requirements can be satisfied by adjusting the temperature corresponding to the smallest value of the loss factor. For example, if the temperature corresponding to the smallest value of the loss factor is lower than the processing temperature, the film in question may be so soft that it will eventually break. Conversely, if the temperature corresponding to the smallest value of the loss factor is higher than the processing temperature, the film in question may be so tough that film extending is made difficult.

In some embodiments of the present invention, the lowest value of the loss factor ranges from 0.13 to 0.19, such as but not limited to 0.138, 0.141, 0.144, 0.149, 0.151, 0.174, 0.177, 0.179 or 0.181. In some embodiments of the invention, the polymer film is a single-layer film structure and has a Tg, and the smallest value of the loss factor of the film occurs at a temperature higher than the Tg. In some other embodiments of the invention, the polymer film is a multilayer film structure and has a highest Tg, and the smallest value of the loss factor of the film occurs at a temperature higher than the highest Tg. As used herein, the symbol Tg refers to glass transition temperature, which in turn refers to a temperature at which a substance is convertible between a glass state, in which the substance has low fluidity, and a highly elastic state, in which the substance has high fluidity and is soft. A temperature at which the loss factor peaks is a glass transition temperature.

As used herein, the term “hydroxyl group content” of a polyvinyl acetal resin refers to a mole faction calculated by dividing the amount of ethylene bonded to the hydroxyl groups by the total amount of ethylene on the carbon backbone and multiplying the quotient by 100%. As used herein, the term “degree of acetalization” of a polyvinyl acetal resin refers to a mole faction calculated by dividing the amount of ethylene bonded to the acetal groups by the total amount of ethylene on the carbon backbone and multiplying the quotient by 100%. As used herein, the term “degree of acetylation” of a polyvinyl acetal resin refers to a mole fraction calculated by subtracting the amount of ethylene bonded to the hydroxyl groups and the amount of ethylene bonded to the acetal groups from the total amount of ethylene on the carbon backbone, dividing the difference by the total amount of ethylene on the carbon backbone, and multiplying the quotient by 100%.

The hydroxyl group content, the degree of acetalization, and the degree of acetylation are calculated according to test results obtained by JIS K6728 “Testing Methods for Polyvinyl Butyral”.

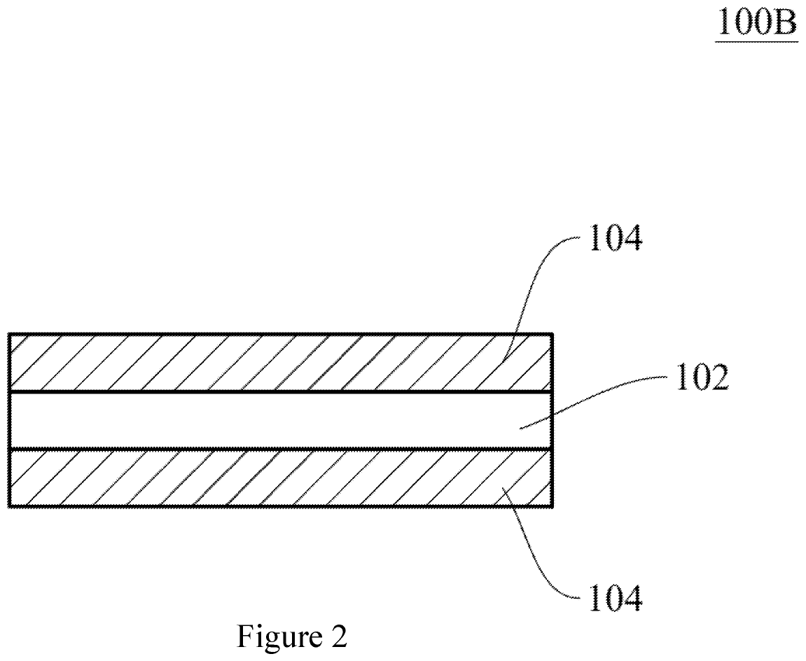

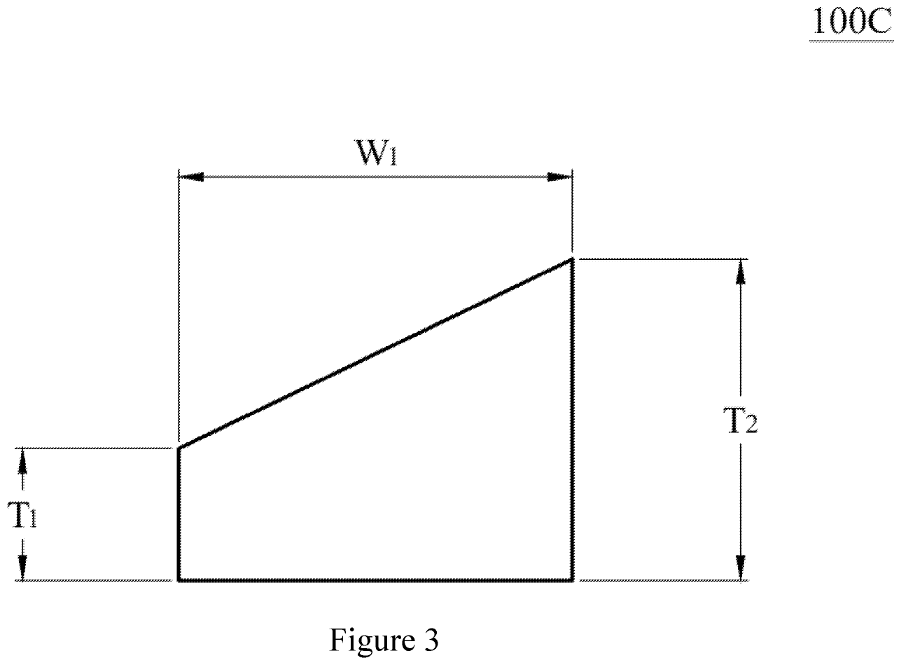

FIG. 1 to FIG. 3 are sectional views of the polymer films in different embodiments of the present invention. The different embodiments represent different structural configurations of the polymer film of the invention respectively. More specifically, the polymer film provided by the invention may be a single-layer film structure (as shown in FIG. 1), a three-layer film structure (as shown in FIG. 2), or a wedge-shaped film structure (as shown in FIG. 3). A person of ordinary skill in the art, however, may adjust or modify the structural configurations disclosed herein according to practical needs without departing from the central concept of the invention.

Single-Layer Film

Referring to FIG. 1, the present invention provides a polymer film 100A that has a single layer 101. The layer 101 has a thickness preferably ranging from 0.2 mm to 2 mm, more preferably from 0.38 mm to 1.52 mm, such as but not limited to 0.38 mm, 0.76 mm, or 1.52 mm. The layer 101 has a glass transition temperature ranging from 10° C. to 35° C., preferably from 25° C. to 35° C., more preferably from 28° C. to 33° C. The invention, however, is not limited by the foregoing numerical ranges or values.

In the polymer film 100A provided by the present invention, the layer 101 includes a polyvinyl acetal resin whose hydroxyl group content ranges from 26 mol % to 31 mol %, preferably from 27.1 mol % to 29.6 mol %, such as but not limited to 27.1, 27.4, 27.5 or 29.6 mol %. The polyvinyl acetal resin in the layer 101 has a degree of acetalization ranging from 68 mol % to 73 mol %, preferably from 69.4 mol % to 71.9 mol %, such as but not limited to 69.4, 71.5, 71.6 or 71.9 mol %. The polyvinyl acetal resin in the layer 101 further has a degree of acetylation ranging from 0.1 mol % to 3.0 mol %, preferably of 1.0 mol %. The invention, however, is not limited by the foregoing numerical ranges or value.

In the polymer film 100A provided by the present invention, the polyvinyl acetal resin in the layer 101 has a bulk density ranging from 0.200 to 0.300, preferably from 0.240 to 0.260, more preferably from 0.249 to 0.258. The invention, however, is not limited by the foregoing numerical ranges. The bulk density is determined according to JIS K6720.

In the polymer film 100A provided by the present invention, the polyvinyl acetal resin in the layer 101 has a number average molecular weight (Mn) ranging from 90,000 to 125,000, preferably from 105,000 to 120,000, more preferably from 106,250 to 115,200. The invention, however, is not limited by the foregoing numerical ranges.

Three-Layer Film

Referring to FIG. 2, the present invention provides a polymer film 100B whose structure includes an interlayer 102 sandwiched between an upper and a lower protective layer 104. Apart from this three-layer structure, however, a person of ordinary skill in the art may form other multilayer films by adding, for example, a fourth layer, a fourth and a fifth layer, or a fourth to a sixth layer as needed, preferably by stacking a plurality of interlayers and a plurality of protective layers in an alternating manner. More specifically, the interlayer 102 has a thickness preferably ranging from 0.11 mm to 0.15 mm, more preferably of 0.13 mm; each protective layer 104 has a thickness preferably ranging from 0.32 mm to 0.35 mm, more preferably of 0.335 mm; and the polymer film 100B has a thickness preferably ranging from 0.5 mm to 2 mm, more preferably from 0.75 mm to 0.85 mm, such as 0.75, 0.76, 0.77, 0.78, 0.8, 0.82 or 0.85 mm. In one preferred embodiment, the polymer film is a three-layer structure consisting of an upper protective layer, a lower protective layer, and an interlayer sandwiched between the two protective layers, and is used as an intermediate film in laminated glass.

In the polymer film 100B provided by the present invention, the interlayer 102 has a glass transition temperature ranging from −10° C. to 6° C., preferably from −8° C. to 0° C., more preferably from −7° C. to −2° C.; the invention, however, is not limited by the foregoing numerical ranges. Each protective layer 104 has a glass transition temperature ranging from 10° C. to 35° C., preferably from 25° C. to 35° C., more preferably from 28° C. to 33° C.; the invention, however, is not limited by the aforesaid numerical ranges, either.

In the polymer film 100B provided by the present invention, the interlayer 102 includes a polyvinyl acetal resin whose hydroxyl group content ranges from 22 mol % to 27 mol %, preferably from 23.8 mol % to 26.2 mol %, such as but not limited to 23.8, 24.9 or 26.2 mol %. The polyvinyl acetal resin in the interlayer 102 has a degree of acetalization ranging from 62 mol % to 68 mol %, preferably from 63.3 mol % to 67.6 mol %, such as but not limited to 63.3, 63.7 or 67.6 mol %. The polyvinyl acetal resin in the interlayer 102 further has a degree of acetylation ranging from 7 mol % to 13 mol %, such as but not limited to 8.6, 10.5 or 11.4 mol %. The invention, however, is not limited by the foregoing numerical ranges. Each protective layer 104, on the other hand, includes a polyvinyl acetal resin whose hydroxyl group content ranges from 26 mol % to 31 mol %, preferably from 27.4 mol % to 30.1 mol %, such as but not limited to 27.4, 27.8 or 30.1 mol %, and the polyvinyl acetal resin in each protective layer 104 has a degree of acetalization ranging from 68 mol % to 73 mol %, preferably from 68.9 mol % to 71.6 mol %, such as but not limited to 68.9, 71.2 or 71.6 mol %, and a degree of acetylation ranging from 0.1 mol % to 3.0 mol %, preferably of 1.0 mol %; the invention, however, is not limited by the aforesaid numerical ranges or value, either.

In the polymer film 100B provided by the present invention, the polyvinyl acetal resin in the interlayer 102 has a bulk density ranging from 0.200 to 0.300, preferably from 0.240 to 0.260, more preferably from 0.247 to 0.258; the invention, however, is not limited by the foregoing numerical ranges. The polyvinyl acetal resin in each protective layer 104 has a bulk density ranging from 0.200 to 0.300, preferably from 0.240 to 0.260, more preferably from 0.251 to 0.257; the invention, however, is not limited by the aforesaid numerical ranges, either.

In the polymer film 100B provided by the present invention, the polyvinyl acetal resin in the interlayer 102 has a number average molecular weight (Mn) ranging from 100,000 to 280,000, preferably from 120,000 to 250,000, more preferably from 150,000 to 225,000; the invention, however, is not limited by the foregoing numerical ranges. The polyvinyl acetal resin in each protective layer 104 has a number average molecular weight (Mn) ranging from 90,000 to 125,000, preferably from 105,000 to 120,000, more preferably from 107,950 to 112,000; the invention, however, is not limited by the aforesaid numerical ranges, either.

Wedge-Shaped Film

Referring to FIG. 3, the present invention further provides a polymer film 100C. In some embodiments of the invention, the polymer film 100C may serve as a film for use in a head-up display (HUD). More specifically, the polymer film 100C has two ends provided respectively as a thick end and a thin end, wherein the thin end has a smaller thickness than the thick end so that when the polymer film 100C is used as a HUD film, images projected on the film are kept from overlapping. The thin end has a thickness T₁, and the thick end has a thickness T₂. The thickness T₁ ranges from 0.7 mm to 0.8 mm, preferably being 0.76 mm. The thickness T2 ranges from 1.4 mm to 1.5 mm, preferably being 1.45 mm. The polymer film 100C demonstrates a film structure that is wedge-shaped as a whole and has a width W₁ of 1200 mm.

The polymer film 100C provided by the present invention includes a polyvinyl acetal resin whose hydroxyl group content, degree of acetalization, and degree of acetylation are similar to those in the single-layer film embodiment described above. More specifically, the polyvinyl acetal resin in the polymer film 100C has a hydroxyl group content ranging from 26 mol % to 31 mol %, preferably from 28.3 mol % to 28.7 mol %, such as but not limited to 28.3 mol % or 28.7 mol %; a degree of acetalization ranging from 68 mol % to 73 mol %, preferably from 70.3 mol % to 70.7 mol %, such as but not limited to 70.3 mol % or 70.7 mol %; and a degree of acetylation ranging from 0.1 mol % to 3.0 mol %, preferably of 1.0 mol %. The invention, however, is not limited by the foregoing numerical ranges or values.

Manufacturing Process of the Polymer Film

FIG. 4 and FIG. 5 show flowcharts of the polymer film manufacturing processes in different embodiments of the present invention respectively. The polymer film manufacturing process shown in FIG. 4 is used to manufacture the single-layer film and wedge-shaped film described above and at least includes steps S100 and S102.

More specifically, step S100 involves mixing a polyvinyl acetal resin with a plasticizer to form a resin composition. The plasticizer is preferably in the amount of 30 to 60 parts by weight, more preferably in the amount of 35 to 45 parts by weight, such as 35, 36, 37, 38, 39, 40, 41, 42, 43, 44, or 45 parts by weight, while the polyvinyl acetal resin is in the amount of 100 parts by weight. The operation temperature and rotation speed of the mixing process can be adjusted according to conventional methods and practical needs; the present invention has no limitation on the details of the process conditions.

In step S102, the resin composition is made into a polymer film. The method for making the polymer film may be a conventional film preparation method such as extrusion or thermoforming. The details of this step can be adjusted according to the configuration of the polymer film to be made. For example, the details can be adjusted in order to make a single-layer film or a wedge-shaped film, which two films have different geometric parameters.

The polymer film manufacturing process shown in FIG. 5 is used to manufacture the three-layer film described above and at least includes steps S200 to S206.

More specifically, step S200 involves mixing a first polyvinyl acetal resin with a plasticizer to form a first resin composition, wherein the plasticizer is preferably in the amount of 60 to 90 parts by weight, more preferably in the amount of 60 to 70 parts by weight, such as 60, 61, 62, 63, 64, 65, 66, 67, 68, 69, or 70 parts by weight, while the first polyvinyl acetal resin is in the amount of 100 parts by weight. The operation temperature and rotation speed of the mixing process can be adjusted according to conventional methods and practical needs; the present invention has no limitation on the details of the process conditions.

In step S202, a second polyvinyl acetal resin is mixed with more plasticizer to form a second resin composition, wherein the plasticizer is preferably in the amount of 30 to 60 parts by weight, more preferably in the amount of 35 to 45 parts by weight, such as 35, 36, 37, 38, 39, 40, 41, 42, 43, 44 or 45 parts by weight, while the second polyvinyl acetal resin is in the amount of 100 parts by weight. The operation temperature and rotation speed of the mixing process can be adjusted according to conventional methods and practical needs; the present invention has no limitation on the details of the process conditions, either.

In step S204, the first resin composition and the second resin composition are made into a first layer and a second layer respectively, wherein the method for making the layers may be a conventional film preparation method such as extrusion or thermoforming. In step S206, one first layer and two second layers are bonded together to form a polymer film, with the first layer serving as an interlayer, and each second layer serving as a protective layer, wherein the bonding method may also be a conventional film preparation method such as extrusion or thermoforming. In at least one embodiment, step S204 and step S206 include coextruding the second resin composition (for forming the protective layers) and the first resin composition (for forming the interlayer) through a T-die so as to produce an intermediate film having a three-layer structure, wherein the structure of the intermediate film is: protective layer/interlayer/protective layer.

Determination of the Molecular Weight of a Polyvinyl Acetal Resin

The molecular weight distribution of a polyvinyl acetal resin is measured by gel permeation chromatography (GPC). More specifically, the polyvinyl acetal resin is dissolved in tetrahydrofuran (THF), and then GPC is performed under the following conditions in order to calculate the molecular weight of the resin based on a ratio in relation to the area corresponding to a polystyrene standard (Waters PS STD).

Device: Waters 1515 PUMP system

Detector: Waters 2414 RI

Elution condition: 1.0 mL/min, THF

Columns: Waters Styragel HR5 THF, Waters Styragel HR4 THF, Waters Styragel HR3 THF, and Waters Styragel HR1 THF.

The polymer film made by either of the foregoing manufacturing processes may serve as a to-be-tested film and be subjected to the following property tests.

Determination of Viscoelasticity

The method used for the determination of viscoelasticity at least includes the following steps: First, a to-be-tested film is cut into a circle with a diameter of 8 mm, and the circular to-be-tested film is put into a thermo-hygrostat for 24 hours, during which the temperature and relative humidity of the thermo-hygrostat are kept at 23° C. and 55% respectively. It is worth noting that in the step of cutting the to-be-tested film into a circle, the circle is cut from a widthwise central portion of the to-be-tested film.

Next, the to-be-tested film is placed in a rotational shear rheometer (Discovery Hybrid Rheometer (DHR) II, manufactured by TA Instrument) in order to carry out viscoelasticity analysis by the oscillation method, wherein the analysis conditions are: the test temperature being lowered from 100° C. to −20° C. at a temperature reduction rate of 3° C/min, the oscillation frequency being set at 1 Hz, the strain of the film under test being kept at 1%, and the fixture pressure being set at 1 N. The loss factor and glass transition temperature of the film under test are derived from the analysis result.

Determination of the Thermal Shrinkage Percentage

The method used to determine the thermal shrinkage percentage employs the following instruments:

Heating oven (model number: Binder FD-115W)

Convection oven

Gage (precision: 1 mm)

The method used to determine the thermal shrinkage percentage at least includes the following steps: First, a to-be-tested film is cut into a 17-cm square, and a 15-cm square mark line is drawn on the square to-be-tested film. Next, the to-be-tested film is hung in the oven, whose temperature is set at 50° C., for 1 hour and then taken out of the oven and placed at room temperature for 1 hour. Lastly, the thermal shrinkage percentage of the film under test is determined.

The thermal shrinkage percentage is calculated as: thermal shrinkage percentage (%)=(length before heating−length after heating)/length before heating*100. Without being limited by specific theories, the greater the calculated value of the thermal shrinkage percentage, the more the film under test tends to be highly fluid and soft; conversely, the smaller the calculated value of the thermal shrinkage percentage, the more the film under test tends to have low fluidity and be hard. In at least one embodiment, a film under test is regarded as having desirable processability if it has a thermal shrinkage percentage ranging from 2% to 5% after receiving a heat treatment at 50° C. for 1 hour.

Determination of the Elongation Percentage

The method used to determine the elongation percentage is based on the test specification of ASTM D412 and employs tension tester AI-7000M manufactured by GOTECH. More specifically, the method at least includes the step of placing a to-be-tested film in an environment with a relative humidity of 23% and a temperature of 23° C. for 2 hours.

The elongation percentage is calculated as: elongation percentage (%)=(length after stretching−length before stretching)/length before stretching*100. In at least one embodiment, a film under test is regarded as having desirable processability if it has an elongation percentage ranging from 220% to 300%. A film may easily deform during the film extending process if its elongation percentage is greater than 300%, and may be difficult to stretch, and thus hinder the film extending process, if its elongation percentage is less than 220%.

### Embodiments 1 to 9

The polymer films in embodiments 1 to 9 of the present invention were provided according to the foregoing contents and were made with different parameters so as to have different properties respectively, and the viscoelasticity, thermal shrinkage percentages, and elongation percentages of the polymer films were analyzed. The parameters and property analysis results of embodiments 1 to 9 are detailed in Table 1.

TABLE 1

| | | | | Embodiment | Embodiment | Embodiment | Embodiment | Embodiment |
|---|---|---|---|---|---|---|---|---|
| | | | Unit | 1 | 2 | 3 | 4 | 5 |
| Inter- | PVB | Solid content | wt % | — | — | — | — | — |
| layer | resin | of PVA for use | | | | | | |
| | | in synthesis | | | | | | |
| | | Bulk density | | — | — | — | — | — |
| | | Molecular | | — | — | — | — | — |
| | | weight | | | | | | |
| | | (Mn) | | | | | | |
| | | Hydroxyl | mol % | — | — | — | — | — |
| | | group | | | | | | |
| | | content | | | | | | |
| | | Degree of | mol % | — | — | — | — | — |
| | | acetylation | | | | | | |
| | | Degree of | mol % | — | — | — | — | — |
| | | acetalization | | | | | | |
| | Plasticizer | Content | phr | — | — | — | — | — |
| | Length | | cm | — | — | — | — | — |
| | Thickness | | mm | — | — | — | — | — |
| | Glass transition | | ° C. | — | — | — | — | — |
| | temperature | | | | | | | |
| Pro- | PVB | Solid content | wt % | 14 | 14 | 14 | 14 | 14 |
| tective | resin | of PVA for use | | | | | | |
| layers/ | | in synthesis | | | | | | |
| single- | | Bulk density | | 0.254 | 0.256 | 0.253 | 0.249 | 0.257 |
| layer | | Molecular | | 112500 | 113400 | 109375 | 114 [symbol] 00 | 106250 |
| film | | weight | | | | | | |
| | | (Mn) | | | | | | |
| | | Hydroxyl | mol % | 27.4 | 29.6 | 27.5 | 27.1 | 28.7 |
| | | group | | | | | | |
| | | content | | | | | | |
| | | Degree of | mol % | 1.0 | 1.0 | 1.0 | 1.0 | 1.0 |
| | | acetylation | | | | | | |
| | | Degree of | mol % | 71.6 | 69.4 | 71.5 | 71.9 | 70.3 |
| | | acetalization | | | | | | |
| | Plasticizer | Content | phr | 4 [symbol] | [symbol] 6 | 40 | 45 | 37 |
| | Length | | cm | 120 | 120 | 120 | 120 | 120 |
| | Thickness | | mm | 0.38 | 0.76 | 0.76 | 1.52 | 0.76-1.45 |
| | Glass transition | | ° C. | 29.48 | [symbol] .84 | 30.29 | 28.68 | [symbol] |
| | temperature | | | | | | | |
| Structure | | | | Single-layer | Single-layer | Single-layer | Single-layer | Wedge-shaped |
| | | | | film | film | film | film | film |
| Temperature at which smallest | | | ° C. | 48.29 | 58. [symbol] | [symbol] 43 | 42.28 | 56.18 |
| value of loss factor occurred | | | | 0.138 | 0.144 | 0.141 | 0.153 | 0.149 |
| Smallest value of loss factor | | | | | | | | |
| Thermal shrinkage percentage | | | % | 4 | 3 | 3 | 4 | 2.5 |
| Elongation percentage | | | % | 269 | 245 | 252 | 239 | 254 |
| | | | | | Embodiment | Embodiment | Embodiment | Embodiment |
| | | | | Unit | 6 | 7 | 8 | 9 |
| | Interlayer | PVB resin | Solid content | wt % | — | 14 | 14 | 14 |
| | | | of PVA for | | | | | |
| | | | use in | | | | | |
| | | | synthesis | | | | | |
| | | | Bulk density | | — | 0.247 | 0.252 | 0.258 |
| | | | Molecular | | — | 175000 | 150000 | 225000 |
| | | | weight | | | | | |
| | | | (Mn) | | | | | |
| | | | Hydroxyl | mol % | — | 23. [symbol] | 24.9 | 26.2 |
| | | | group | | | | | |
| | | | content | | | | | |
| | | | Degree of | mol % | — | 8.6 | 11.4 | 10.5 |
| | | | acetylation | | | | | |
| | | | Degree of | mol % | — | 67.6 | 63.7 | 63.3 |
| | | | acetalization | | | | | |
| | | Plasticizer | Content | phr | — | 70 | 60 | 65 |
| | | Length | | cm | — | 120 | 120 | 120 |
| | | Thickness | | mm | — | 0.13 | 0.13 | 0. [symbol] |
| | | Glass transition temperature | | ° C. | — | −6.98 | −2.62 | −3.35 |
| | Protective | PVB resin | Solid content | wt % | 14 | 14 | 14 | 14 |
| | layers/ | | of PVA for | | | | | |
| | single- | | use in | | | | | |
| | layer | | synthesis | | | | | |
| | film | | Bulk density | | 0.258 | 0.251 | 0.253 | 0.256 |
| | | | Molecular | | 115200 | 107950 | 111125 | 112000 |
| | | | weight | | | | | |
| | | | (Mn) | | | | | |
| | | | Hydroxyl | mol % | 28.3 | 27.4 | 30.1 | 27.8 |
| | | | group | | | | | |
| | | | content | | | | | |
| | | | Degree of | mol % | 1.0 | 1.0 | 1.0 | 1.0 |
| | | | acetylation | | | | | |
| | | | Degree of | mol % | 70.7 | 71.6 | 68.9 | 71.2 |
| | | | acetalization | | | | | |
| | | Plasticizer | Content | phr | 38 | 4 [symbol] | 35 | 39 |

| | | | | | |
|---|---|---|---|---|---|
| Length | cm | 120 | 120 | 120 | 120 |
| Thickness | mm | 0.76-1.45 | 0.335 | 0.335 | 0.335 |
| Glass transition temperature | ° C. | | | | |

| | | | | | |
|---|---|---|---|---|---|
| Structure | | Wedge-shaped | Three-layer | Three-layer | Three-layer |
| | | film | film | film | film |
| Temperature at which smallest value | ° C. | 54.21 | 49.77 | 59.14 | 52.23 |
| of loss factor occurred | | 0.174 | 0.177 | 0.181 | 0.179 |
| Smallest value of loss factor | | | | | |
| Thermal shrinkage percentage | % | 3.5 | 3 | 2.5 | 2 |
| Elongation percentage | % | 255 | 258 | 269 | 254 |

[symbol]

indicates data missing or illegible when filed

The preparation method of the polymer films in embodiments 1 to 9 is briefly described as follows:

Preparation of a resin composition for use in the protective layer(s): 100 parts by weight of a first polyvinyl acetal resin (a polyvinyl butyral (PVB) resin was used by way of example) and 35 to 45 parts by weight of a plasticizer (triethylene glycol bis(2-ethylhexanoate) (3GO) was used by way of example) were sufficiently mixed in a mixer to produce a resin composition for use in the protective layer(s).

Preparation of a resin composition for use in the interlayer: 100 parts by weight of a second polyvinyl acetal resin (the same PVB resin was used by way of example) and 60 to 70 parts by weight of the same plasticizer (i.e., 3GO) were sufficiently mixed in a mixer to produce a resin composition for use in the interlayer

Preparation of a film: In embodiments 1 to 4, the resin composition for use in the protective layer(s) was extruded with an extruder to form single-layer films whose thicknesses ranged from 0.38 mm to 1.52 mm. In embodiments 5 and 6, the aforesaid resin composition was extruded with an extruder to form wedge-shaped films (i.e., HUD films), which were thicker at one end than at the opposite end, with the thick end being 1.45 mm thick, the thin end being 0.76 mm thick, and each HUD film being approximately 1200 mm wide. In embodiments 7 to 9, the resin composition for use in the protective layers(s) and the resin composition for use in the interlayer were coextruded through a T-die to form three-layer films that were 0.8 mm thick and were of the structure: protective layer/interlayer/protective layer (0.335 mm/0.13 mm/0.335 mm).

### COMPARATIVE EXAMPLES 1 to 8

The polymer films in comparative examples 1 to 8 were provided by a preparation method similar to that used for embodiments 1 to 9 (the differences can be known by comparing Table 2 with Table 1), and the viscoelasticity, thermal shrinkage percentages, and elongation percentages of the polymer films were analyzed. The analysis and evaluation methods were the same as those used for embodiments 1 to 9.

It should be pointed out that the polymer films in comparative examples 1 to 4 are single-layer films, that the polymer films in comparative examples 5 and 6 are wedge-shaped films (i.e., HUD films), and that the polymer films in comparative examples 7 and 8 are three-layer films (with an interlayer sandwiched between an upper protective layer and a lower protective layer). The parameters and property analysis results of comparative examples 1 to 8 are detailed in Table 2.

TABLE 2

| | | | | Comparative | Comparative | Comparative | Comparative |
|---|---|---|---|---|---|---|---|
| | | | Unit | example 1 | example 2 | example 3 | example 4 |
| Interlayer | PVB [symbol] | Solid content of | wt % | — | — | — | — |
| | | PVA for use in | | | | | |
| | | synthesis | | | | | |
| | | Bulk density | | — | — | — | — |
| | | Molecular weight | | — | — | — | — |
| | | (Mn) | | | | | |
| | | Hydroxyl group | mol % | — | — | — | — |
| | | content | | | | | |
| | | Degree of | mol % | — | — | — | — |
| | | acetylation | | | | | |
| | | Degree of | mol % | — | — | — | — |
| | | acetalization | | | | | |
| | Plasticizer | Content | pbr | — | — | — | — |
| | Length | | cm | — | — | — | — |
| | Thickness | | mm | — | — | — | — |
| | Glass transition temperature | | ° C. | — | — | — | — |
| Protective | PVB resin | Solid content of | wt % | 14 | 14 | 14 | 14 |
| layers/ | | PVA for use in | | | | | |
| single- | | synthesis | | | | | |
| layer | | Bulk density | | 0.256 | 0.257 | 0.253 | 0.256 |
| film | | Molecular weight | | 106250 | 107950 | 112000 | 112500 |
| | | (Mn) | | | | | |
| | | Hydroxyl group | mol % | 23.6 | [symbol] 3.6 | 26.4 | 31.7 |
| | | content | | | | | |
| | | Degree of | mol % | 1.0 | 1.0 | 1.0 | 1.0 |
| | | acetylation | | | | | |
| | | Degree of | mol % | 7 [symbol] .4 | 6 [symbol] .4 | 72.6 | 67.3 |
| | | acetalization | | | | | |
| | Plasticizer | Content | p [symbol] r | 52 | 31 | 46 | [symbol] 3 |
| | Length | | cm | 120 | 120 | 120 | 120 |
| | Thickness | | mm | 0 [symbol] 38 | 0 [symbol] 76 | 0.76 | 1.52 |
| | Glass transition temperature | | ° C. | 24.15 | 35.24 | 36 [symbol] 42 | 34 [symbol] 62 |
| Structure | | | | Single-layer | Single-layer | Single-layer | Single-layer |
| | | | | film | film | film | film |
| Temperature at which smallest value of loss | | | ° C. | 24.37 | 65.28 | 34.52 | 62.38 |
| factor occurred | | | | 0.149 | 0.157 | 0.139 | 0.148 |
| Smallest value of loss factor | | | | | | | |
| Thermal shrinkage percentage | | | % | 11 | 0. [symbol] | 12 | 0.0 |
| Elongation percentage | | | % | 349 | 127 | 352 | 11 [symbol] |
| | | | | Comparative | Comparative | Comparative | Comparative |
| | | | Unit | example 5 | example 6 | example 7 | example 8 |
| Interlayer | PVB [symbol] | Solid content of | wt % | — | — | 14 | 14 |
| | | PVA for use in | | | | | |
| | | synthesis | | | | | |
| | | Bulk density | | — | — | 0.247 | 0.252 |
| | | Molecular weight | | — | — | 175000 | 150000 |
| | | (Mn) | | | | | |
| | | Hydroxyl group | mol % | — | — | 23.8 | 24.9 |
| | | content | | | | | |
| | | Degree of | mol % | — | — | 8.6 | [symbol] .4 |
| | | acetylation | | | | | |
| | | Degree of | mol % | — | — | 67.6 | 6 [symbol] .7 |
| | | acetalization | | | | | |
| | Plasticizer | Content | pbr | — | — | 70 | 60 |
| | Length | | cm | — | — | 120 | 120 |
| | Thickness | | mm | — | — | 0.13 | 0.13 |
| | Glass transition temperature | | ° C. | — | — | −6.08 | −2.62 |
| Protective | PVB resin | Solid content of | wt % | 14 | 14 | 14 | 14 |
| layers/ | | PVA for use in | | | | | |
| single- | | synthesis | | | | | |
| layer | | Bulk density | | 0.255 | 0.249 | 0.251 | 0.2 [symbol] 7 |
| film | | Molecular weight | | 109375 | 11 [symbol] 400 | 11125 | 112000 |
| | | (Mn) | | | | | |
| | | Hydroxyl group | mol % | 24. [symbol] | 34.2 | 22.8 | 35.7 |
| | | content | | | | | |
| | | Degree of | mol % | 1.0 | 1.0 | 1.0 | 1.0 |
| | | acetylation | | | | | |
| | | Degree of | mol % | 74.9 | 64.8 | 76 [symbol] 2 | 63.3 |
| | | acetalization | | | | | |
| | Plasticizer | Content | p [symbol] r | 48 | 29 | 55 | 27 |

| | | | | | |
|---|---|---|---|---|---|
| Length | cm | cm | 120 | 120 | 120 |
| Thickness | mm | 0.76-1 [symbol] 45 | 0.76-1 [symbol] 45 | 0. [symbol] 35 | 0. [symbol] 35 |
| Glass transition temperature | ° C. | 24.41 | 15. [symbol] 4 | 23.57 | 36.28 |

| | | | | | |
|---|---|---|---|---|---|
| Structure | | Wedge-shaped | Wedge-shaped | Three-layer | Three-layer |
| | | film | film | film | film |
| Temperature at which smallest value of loss | ° C. | 25.62 | 67.73 | 23. [symbol] 7 | 68.21 |
| factor occurred | | 0.166 | 0.173 | 0.145 | 0.173 |
| Smallest value of loss factor | | | | | |
| Thermal shrinkage percentage | % | 10 | 1.2 | 10.5 | 1.2 |
| Elongation percentage | % | [symbol] 37 | 131 | 306 | 127 |

[symbol]

indicates data missing or illegible when filed

As can be seen in Table 1 and Table 2, the temperatures at which the smallest values of the loss factors of the polymer films in embodiments 1 to 9 occurred, be the films single-layer or multilayer, had been modulated to range from 40° C. to 60° C. such that the polymer films in embodiments 1 to 9 exhibited higher fluidity and processability than those in comparative examples 1 to 8. As can be further understood from Table 2, that all the polymer films in comparative examples 1, 3, 5, and 7 had the smallest values of their loss factors at temperatures lower than 40° C. and had thermal shrinkage percentages greater than 5% and elongation percentages greater than 300% indicates that the polymer films in comparative examples 1, 3, 5, and 7 were excessively soft and would easily deform or break during a film extending process, and that all the polymer films in comparative examples 2, 4, 6, and 8 had the smallest values of their loss factors at temperatures higher than 60° C. and had thermal shrinkage percentages less than 2% and elongation percentages less than 220% indicates that the polymer films in comparative examples 2, 4, 6, and 8 were excessively tough and would therefore make film extending difficult.

According to the above, the present invention provides a polymer film that includes a polyvinyl acetal resin and a plasticizer, wherein the polymer film may have a single layer or multiple layers, and wherein the smallest value of the loss factor of the polymer film occurs at a temperature ranging from 40° C. to 60° C. The polymer film provided by the invention has desirable fluidity and processability.

Unless otherwise defined herein, scientific and technical terms used in connection with this application shall have the ordinary meaning as understood by those of ordinary skill in the art. Furthermore, unless otherwise required by context, singular terms shall include pluralities and plural terms shall include singular.

The above is the detailed description of the present invention, but the above is merely the preferred embodiments of the present invention, and should not limit the scope of implementation of the present invention, that is, all equivalent changes and modifications according to the scope of the patent application of the present invention should still fall within the scope of the patent of the present invention.

What is claimed is:

1. A polymer film, comprising a polyvinyl acetal resin and a plasticizer, wherein the polymer film is single-layer or multilayer, and a smallest value of a loss factor of the polymer film occurs at a temperature ranging from 40° C. to 60° C.

2. The polymer film of claim 1, wherein the smallest value of the loss factor ranges from 0.13 to 0.19.

3. The polymer film of claim 2, wherein when the polymer film is single-layer, the temperature at which the smallest value of the loss factor occurs is higher than a glass transition temperature of the polymer film; or when the polymer film is multilayer, the temperature at which the smallest value of the loss factor occurs is higher than a highest glass transition temperature of the polymer film.

4. The polymer film of claim 1, wherein the polyvinyl acetal resin is polyvinyl butyral (PVB).

5. The polymer film of claim 1, wherein the polymer film has a thickness ranging from 0.2 mm to 2 mm.

6. The polymer film of claim 1, wherein after receiving a heat treatment at 50° C. for 1 hour, the polymer film has a thermal shrinkage percentage ranging from 2% to 5%.

7. The polymer film of claim 1, wherein when measured according to ASTM D412, the polymer film has an elongation percentage ranging from 220% to 300%.

8. The polymer film of claim 1, wherein when the polymer film is single-layer, the polyvinyl acetal resin in the polymer film has a hydroxyl group content ranging from 27 mol % to 31 mol % and/or a degree of acetalization ranging from 68 mol % to 72 mol %.

9. The polymer film of claim 1, wherein when the polymer film is single-layer, the plasticizer in the polymer film is in an amount of 30 to 60 parts by weight while the polyvinyl acetal resin in the polymer film is in an amount of 100 parts by weight.

10. The polymer film of claim 1, wherein when the polymer film is single-layer, the polymer film is a film for use in a head-up display (HUD).

11. The polymer film of claim 10, wherein the polymer film has a thick end and a thin end, and the thin end has a smaller thickness than the thick end.

12. The polymer film of claim 1, wherein when the polymer film is multilayer, the polymer film is a three-layer structure consisting of an upper protective layer, a lower protective layer, and an interlayer sandwiched between the upper protective layer and the lower protective layer.

13. The polymer film of claim 12, wherein the polyvinyl acetal resin in each said protective layer has a hydroxyl group content ranging from 27 mol % to 31 mol % and/or a degree of acetalization ranging from 68 mol % to 72 mol %.

14. The polymer film of claim 12, wherein the plasticizer in each said protective layer is in an amount of 30 to 60 parts by weight while the polyvinyl acetal resin in each said protective layer is in an amount of 100 parts by weight.

15. The polymer film of claim 12, wherein the polyvinyl acetal resin in the interlayer has an hydroxyl group content ranging from 22 mol % to 27 mol % and/or a degree of acetalization ranging from 62 mol % to 68 mol %.

16. The polymer film of claim 12, wherein the plasticizer in the interlayer is in an amount of 60 to 90 parts by weight while the polyvinyl acetal resin in the interlayer is in an amount of 100 parts by weight.

17. The polymer film of claim 12, wherein the polymer film is used as an intermediate film in laminated glass and has a thickness ranging from 0.5 mm to 2 mm.

18. The polymer film of claim 17, wherein the thickness of the polymer film is 0.8 mm, with the upper protective layer having a thickness of 0.335 mm, the interlayer having a thickness of 0.13 mm, and the lower protective layer having a thickness of 0.335 mm.
